(19) United States
(12) Patent Application Publication
(10) Pub. No.: US 2010/0260537 A1
(43) Pub. Date: Oct. 14, 2010

(54) CONNECTING STRUCTURE FOR SWIVEL SHAFTS

(75) Inventor: Chao-Lin Qin, Shenzhen City (CN)

Correspondence Address: Altis Law Group, Inc.;ATTN: Steven Reiss, 288 SOUTH MAYO AVENUE, CITY OF INDUSTRY, CA, 91789, US

(73) Assignees: HONG FU JIN PRECISION INDUSTRY (ShenZhen) CO., LTD, Shenzhen City (CN); HON HAI PRECISION INDUSTRY CO., LTD., Tu-Cheng (TW)

(21) Appl. No.: 12/551,690

(22) Filed: Sep. 1, 2009

(30) Foreign Application Priority Data
Apr. 9, 2009 (CN) 200910301452.2

(51) Int. Cl. F16C 11/10

(52) U.S. Cl. 403/122

(57) ABSTRACT

A connecting structure for a first swivel shaft and a second swivel shaft includes a connecting plug, a connecting socket, and positioning members. The connecting plug extends from an end of the first swivel shaft and includes an extending portion having engaging surfaces. The connecting socket is formed on an end of the second swivel shaft and defines a receiving hole receiving the extending portion of the connecting plug. The positioning members are positioned in the inner surface of the receiving hole. Each of the positioning members includes a resisting point abutting one engaging surface of the extending portion such that the extending portion of the connecting plug is non-rotatable relative to the connecting socket. Projections of the resisting points of the positioning members form a circle concentric with the second swivel shaft on a plane perpendicular to the axis of the second swivel shaft.

### BACKGROUND

1. Technical Field

The present disclosure relates to a connecting structure and, more particularly, to a connecting structure for swivel shafts.

2. Description of Related Art

A swivel shaft may be connected to another swivel shaft by a connecting structure so that the two shafts can rotate together.

A commonly used connecting structure includes a connecting plug formed on an end of a first swivel shaft and a connecting socket fixed on an end of a second swivel shaft. The connecting plug is a substantially regular prism. The connecting socket and the second swivel shaft are aligned along a common axis. The connecting socket is substantially cylindrical and defines a polygonal hole corresponding to the shape of the connecting plug. In use, the connecting plug is received in the polygonal hole of the connecting socket such that the first swivel shaft and the second swivel shaft can rotate together. When the second swivel shaft does not need to rotate together with the first pivot shaft, the connecting plug is detached from the polygonal hole of the connecting socket.

The connecting socket is generally manufactured by turning on, for example, a metal lathe. However, it is difficult to form the polygonal hole on the metal lathe. The distance between the center of the polygonal hole and one border of the polygonal hole easily differs from the distance between the center of the polygonal hole and the other borders of the polygonal hole. As a result, when the connecting plug is received in the connecting socket, the axis of the second swivel shaft deviates from the axis of the first swivel shaft, causing vibration and compromising stability.

Therefore, there is room for improvement within the art.

### BRIEF DESCRIPTION OF THE DRAWINGS

The components in the drawings are not necessarily drawn to scale, the emphasis instead being placed upon clearly illustrating the principles of the present disclosure. Moreover, in the drawings, like reference numerals designate corresponding parts throughout the several views, and all the views are schematic.

FIG. 1 is a partially exploded, isometric view of one embodiment of a connecting structure, the connecting structure including a connecting plug and a connecting socket.

FIG. 2 is a cross-section of the connecting socket of FIG. 1.

FIG. 3 is a top view of the connecting socket of FIG. 1.

FIG. 4 is a cross-section of the connecting structure when the connecting plug is received in the connecting socket.

### DETAILED DESCRIPTION

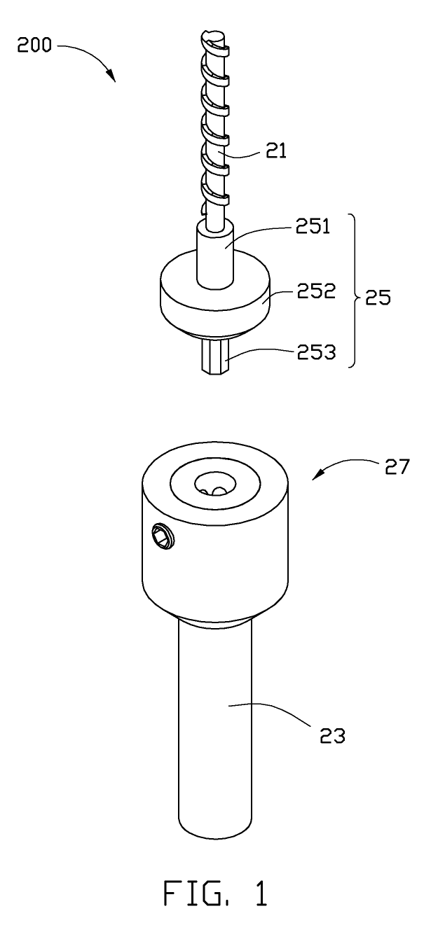

Referring to FIG. 1, one embodiment of a connecting structure 200 connects a first swivel shaft 21 to a second swivel shaft 23 and includes a connecting plug 25 extending from an end of the first swivel shaft 21 and a connecting socket 27 formed on an end of the second swivel shaft 23.

The connecting plug 25 and the first swivel shaft 21 are substantially aligned along a common axis. The connecting plug includes a connecting portion 251, a flange 252, and an extending portion 253 in that order. The connecting portion 251 is fixed to the first swivel shaft 21. The flange 252 is substantially cylindrical and larger than both the connecting portion 251 and the extending portion 253. The extending portion 253 is a substantially regular prism and includes a plurality of engaging surfaces (not labeled) configured to engage the connecting socket 27. In the illustrated embodiment, the extending portion 253 is a substantially regular hexagonal prism and the engaging surfaces are six side surfaces thereof.

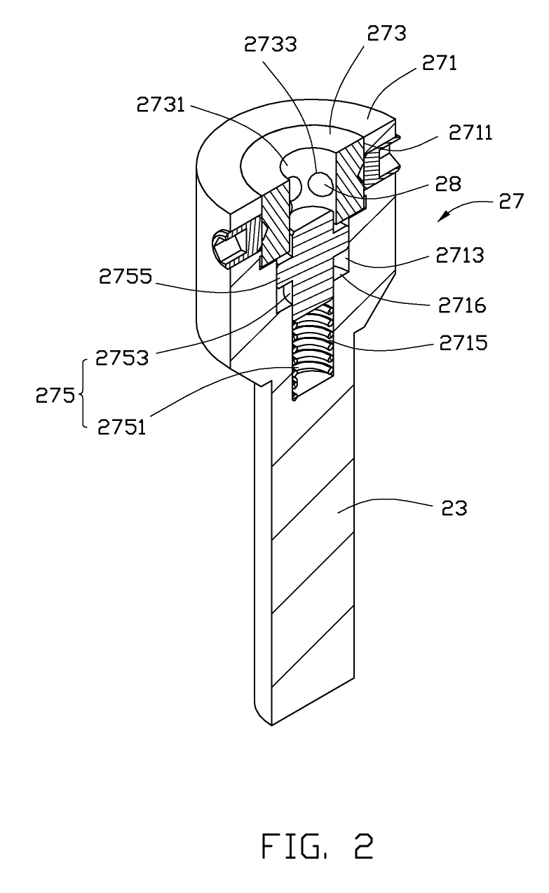

Referring to FIG. 2, the connecting socket 27 includes a main body 271, a barrel 273, a contact structure 275, and a plurality of positioning members 28. The main body 271 is substantially cylindrical. The main body 271 and the second swivel shaft 23 are substantially aligned along a common axis. The main body 271 defines a positioning hole 2711, a sliding hole 2713, and a receiving groove 2715 from top to bottom in that order. The positioning hole 2711 is in an end of the connecting socket 27 away from the second swivel shaft 23. The barrel 273 defines a circular receiving hole 2731 in a middle portion thereof receiving the extending portion 253 of the connecting plug 25. An inner surface of the receiving hole 2731 defines a plurality of positioning grooves 2733 receiving the positioning members 28. Each positioning member 28 includes a resisting point (not labeled) to abut one of the engaging surfaces of the extending portion 253 of the connecting plug 25. In the illustrated embodiment, six positioning grooves 2733 are evenly defined in the inner surface of the receiving hole 2731 in a circle. The positioning members 28 are steel balls having great strength and precisely formed, so that the coaxiality of the connecting structure 200 is improved. The positioning grooves 2733 are substantially spherical. The diameter of the receiving groove 2715 and the diameter of the receiving hole 2731 are both less than a diameter of the sliding hole 2713. A stepped portion 2716 is formed on a common boundary of the receiving groove 2715 and the sliding hole 2713. The size of the positioning hole 2711 corresponds to a size of the barrel 273. The barrel 273 may be fixed in the positioning hole 2711 by fasteners (not labeled) such as screws.

The contact structure 275 includes an elastic member 2751 and a contact member 2753. The elastic member 2751 may be a spring and includes a first end abutting a bottom surface of the receiving groove 2715 and a second end abutting the contact member 2753. The contact member 2753 may be a shaft including a sliding flange 2755 formed on a middle portion thereof. The sliding flange 2755 corresponds to the sliding hole 2713. Opposite ends of the contact member 2753 are respectively received in the receiving hole 2731 and the receiving groove 2715. Since the diameter of the sliding hole 2713 exceeds the diameter of the receiving groove 2715 and the diameter of the receiving hole 2731, the sliding flange 2755 is slidable between the barrel 273 and the stepped portion 2716. Thus, the sliding range of the sliding flange 2755 is restricted and the contact member 2753 is prevented from detaching from the sliding hole 2713.

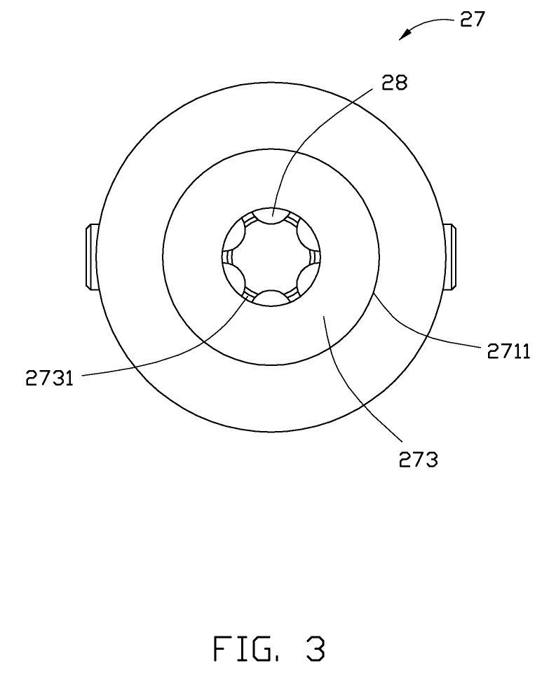

Referring also to FIG. 3, the positioning hole 2711 of the connecting socket 27 and the receiving hole 2731 of the barrel 273 are concentric. The positioning members 28 are symmetrically positioned relative to the center of the receiving hole 2731, and each positioning member 28 corresponds to one engaging surface of the extending portion 253. During manufacture, the positioning hole 2711 can be formed by turning, and utilized as a benchmark to form the receiving hole 2731 in the barrel 273 by turning. A metal lathe provides precise formation of circular holes, thus it is easy to achieve high coaxiality between the positioning hole 2711 of the connecting socket 27 and the receiving hole 2731 of the barrel 273. The positioning grooves 2733 are substantially spherical, so that the shape and precision are easily controlled, such that the resisting points of the positioning members 28 can conveniently be aligned in a circle. As a result, the circle where the resisting points of the positioning members 28 are aligned, the positioning hole 2711, and the receiving hole 2731 are concentric.

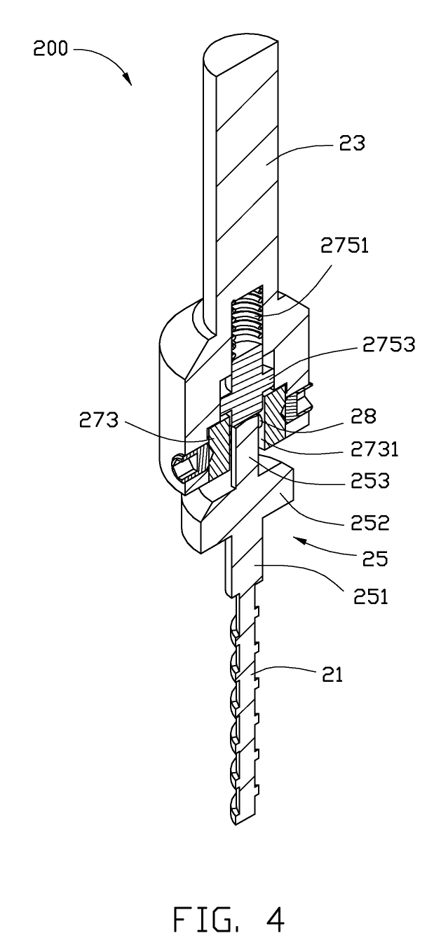

Referring also to FIG. 4, in use, the flange 252 of the connecting plug 25 abuts an end surface of the connecting socket 27 and the extending portion 253 of the connecting plug 25 is received in the receiving hole 2731 of the barrel 273. The engaging surfaces of the extending portion 253 abut the positioning members 28 such that the extending portion 253 is non-rotatably received in the connecting socket 27. Thus, the extending portion 253 and the connecting socket 27 are substantially aligned along a common axis along which the first swivel shaft 21 and the second swivel shaft 23 can rotate. The positioning members 28 are steel balls, allowing the extending portion 253 of the connecting plug 25 to easily slide past the positioning members 28 and engage or detach from the receiving hole 2731 of the barrel 273. The elastic member 2751 impels the contact member 2753 to abut the extending portion 253, so that the rotation position of the connecting plug 25 is stable and vibration thereof is reduced.

Since the resisting points of the positioning members 28 are aligned in the receiving hole 2731 of the barrel 273 in a circle to respectively abut the engaging surfaces of the extending portion 253 of the connecting plug 25, the extending portion 253 of the connecting plug 25 is non-rotatably received in the receiving hole 2731 so that the connecting plug 25 and the connecting socket 27 are substantially aligned along a common axis. Therefore, the axis of the first swivel shaft 21 largely conforms to the axis of the second swivel shaft 23. When the positioning members 28 are evenly aligned in the receiving hole 2731 of the barrel 273, the connecting structure 200 is better able to prevent the axis of the first swivel shaft 21 from deviating from the axis of the second swivel shaft 23.

The receiving hole 2731 is not limited to a circular shape, and may be other shapes if the resisting points of the positioning members 28 are aligned in a circle in the receiving hole 2731.

In an alternative embodiment, the resisting points of the positioning members 28 are not aligned in a circle in the receiving hole 2731, but rather in different circles whose centers are positioned at the axis of the second swivel shaft 23. Further, the projections of the resisting points of the positioning members 28 form a circle concentric with the second swivel shaft 23 on a plane perpendicular to the axis of the second swivel shaft 23.

The barrel 273 may be integrally formed with the main body 271 of the connecting socket 27. The positioning members 28 may be hemispherical protrusions directly formed in the receiving hole 2731.

The shape of the extending portion 253 of the connecting plug 25 is not limited to a regular hexagonal prism, and may be another shape such as a regular quadrangular prism, and a regular eight-sided prism. Accordingly, the number of positioning members 28 corresponds to the number of side surfaces of the extending portion 253 of the connecting plug 25. Further, the extending portion 253 of the connecting plug 25 may be substantially cylindrical and defines a plurality of sliding grooves therein corresponding to the positioning members 28 such that the resisting points of the positioning members 28 can abut bottom surfaces in the sliding grooves.

The number of positioning members 28 may be less than that of the engaging surfaces of the extending portion 253 of the connecting plug, for example, the extending portion 253 can include eight engaging surfaces and the number of positioning members 28 is four.

It is believed that the present embodiments and their advantages will be understood from the foregoing description, and it will be apparent that various changes may be made thereto without departing from the spirit and scope of the embodiments or sacrificing all of their material advantages.

What is claimed is:

1. A connecting structure for a first swivel shaft and a second swivel shaft, the connecting structure comprising:
a connecting plug extending from an end of the first swivel shaft, the connecting plug comprising an extending portion having a plurality of engaging surfaces;
a connecting socket formed on an end of the second swivel shaft, the connecting socket defining a receiving hole receiving the extending portion of the connecting plug; and
a plurality of positioning members positioned in the inner surface of the receiving hole, each of the positioning members comprising a resisting point abutting one of the engaging surfaces of the extending portion such that the extending portion of the connecting plug is non-rotatable relative to the connecting socket, wherein projections of the resisting points of the positioning members form a circle concentric with the second swivel shaft on a plane perpendicular to the axis of the second swivel shaft.

2. The connecting structure of claim 1, wherein the receiving hole is a circular hole and the positioning members are steel balls.

3. The connecting structure of claim 2, wherein the extending portion is a substantially regular prism and the engaging surfaces are side surfaces of the extending portion.

4. The connecting structure of claim 1, wherein the connecting socket comprises a main body defining a positioning hole therein, and a barrel fixed in the positioning hole; the receiving hole is defined in a middle portion of the barrel and the positioning members are positioned in a sidewall of the barrel.

5. The connecting structure of claim 4, wherein the main body and the second swivel shaft are substantially aligned along a common axis; the positioning hole of the connecting socket and the receiving hole of the barrel are concentric.

6. The connecting structure of claim 4, wherein a plurality of positioning grooves are evenly defined in the inner surface of the receiving hole in a circle receiving the positioning members; the resisting points of the positioning members are coplanar and substantially aligned in a common circle.

7. The connecting structure of claim 4, wherein the connecting socket further comprises a contact structure received in the connecting socket, the contact structure comprising an elastic member and a contact member; a first end of the contact member abuts the elastic member, and a second end of the contact member is capable of abutting an end of the extending portion.

8. The connecting structure of claim 7, wherein the connecting socket defines a sliding hole communicating the positioning hole to a receiving groove in which the elastic member is received; the contact member comprises a sliding flange formed on a middle portion thereof and slidably received in the receiving groove.

9. A connecting structure for a first swivel shaft and a second swivel shaft, the connecting structure comprising:
a connecting plug extending from an end of the first swivel shaft, the connecting plug comprising an extending portion comprising a plurality of side surfaces;
a connecting socket formed on an end of the second swivel shaft, the connecting socket defining a circular receiving hole receiving the extending portion of the connecting plug, wherein a plurality of positioning grooves are evenly defined in the inner surface of the receiving hole in a circle; and
a plurality of positioning members positioned in the positioning grooves, each of the positioning members comprising a resisting point abutting one of the side surfaces of the extending portion such that the extending portion of the connecting plug is non-rotatable relative to the connecting socket, wherein the resisting points of the positioning members are coplanar and form a circle concentric with the second swivel shaft.

10. The connecting structure of claim 9, wherein the positioning members are steel balls.

11. The connecting structure of claim 9, wherein the connecting socket comprises a main body defining a positioning hole therein, and a barrel fixed in the positioning hole; the receiving hole is defined in a middle portion of the barrel and the positioning members are positioned in a sidewall of the barrel.

12. The connecting structure of claim 11, wherein the main body and the second swivel shaft are substantially aligned along a common axis; the positioning hole of the connecting socket and the receiving hole of the barrel are concentric.

13. The connecting structure of claim 9, wherein the extending portion is a substantially regular prism.

14. The connecting structure of claim 11, wherein the connecting socket further comprises a contact structure received in the connecting socket, the contact structure comprising an elastic member and a contact member; a first end of the contact member abuts the elastic member, and a second end of the contact member is capable of abutting an end of the extending portion.

15. The connecting structure of claim 14, wherein the connecting socket defines a sliding hole communicating the positioning hole with a receiving groove, in which the elastic member is received; the contact member comprises a sliding flange formed on a middle portion thereof and slidably received in the receiving groove.
